(19) United States
(12) Patent Application Publication
(10) Pub. No.: US 2013/0245991 A1
(43) Pub. Date: Sep. 19, 2013

(54) METHOD FOR DETERMINING THE REMAINING LIFE OF A THERMAL MASS IN A SHIPPING PACKAGE WHILE IN TRANSIT

(71) Applicant: Richard Kriss, Poulsby, WA (US)

(72) Inventor: Richard Kriss, Poulsby, WA (US)

(21) Appl. No.: 13/781,698

(22) Filed: Feb. 28, 2013

Related U.S. Application Data
(60) Provisional application No. 61/604,336, filed on Feb. 28, 2012.

(51) Int. Cl. G06Q 50/28; G01G 19/414

(52) U.S. Cl. CPC G06Q 50/28; G01G 19/414
USPC 702/150; 702/174

(57) ABSTRACT

A shipping container is described for use with methods for monitoring and controlling shipment of a temperature controlled material and determining the remaining useful life of a Thermal Source contained within the shipping container. The container comprises an inner enclosure adapted to carry one or more commodities during shipment, a bladder conformed to the inner surface of the inner chamber, or a plate upon which commodities are place, and instrumented with at least one transducer and at least one processing device configured to receive measurements from the at least one transducer. The processing device communicates the measurements to a networked device upon detecting the presence of a network. The networked device may transmit commands to the processing device that causes the processing device to adjust a configuration parameter.

### CLAIM OF PRIORITY UNDER 35 U.S.C. §119

The present Application for Patent claims priority to Provisional Application No. 61/604,336 filed Feb. 28, 2012, and assigned to the assignee hereof and hereby expressly incorporated by reference herein.

### FIELD OF THE INVENTION

The present invention is in the field of methods for monitoring and controlling shipment of a temperature controlled material in a cold-chain application.

### BACKGROUND OF THE INVENTION

The transport of temperature-stabilized commodities such as research specimens and pharmaceuticals and other biologics (“commodities”) exposes the shipper to risk, uncertainty and high costs particularly when international shipping is involved. When a shipping package or container is in the hands of a shipping company, the shipper cannot easily determine the location and status of the shipment with respect to a planned delivery date, whether the commodities in the shipping package have been exposed to excessive temperatures, shock, vibration or tilt, and most importantly, whether cold-source commodities contained within the package such as dry-ice or liquid nitrogen (“Thermal Source”), have an adequate charge remaining to last for the expected (or unexpected) duration of the shipment.

In an attempt to mitigate these risks, shippers place remote telemetry devices within the package to log and sometimes transmit sensor data. Package monitoring devices are generally designed as offline dataloggers where the data is harvested by connecting the datalogger to a computer system through a universal serial bus (USB) connection after the shipment reaches its destination, when it is generally too late to intervene to replenish the Thermal Source during shipment for example.

Shippers of temperature stabilized products such as pharmaceuticals and research commodities see significant opportunity in new overseas markets. However, shipping commodities into those markets involves significantly greater risk and higher cost due to longer shipping times, prolonged exposure to shock and vibration and greater potential that the Thermal Source will be dissipated before the shipment is completed. To mitigate these risks, clinical trial research companies over allocate trial experiments to provide a margin of safety so that specimen degradation and drug losses attributable to the shipping process does not cause an insufficiency of clinical trial data. Today, the cost of developing a new drug averages $800 million. Although there is no set rule for the amount of over-allocation, five to 10 percent over-allocation is often mentioned. Taking the more conservative value of five percent, the cost of over allocation and the impact of specimen or drug losses due to risk factors in the cold-chain shipping process, it can be estimated that in a typical clinical trial, $40 million of trial costs could be avoided if risk factors in the shipping process were avoided or mitigated.

There is a need in the industry to mitigate these risks factors which can be achieved with more aggressive in-situ monitoring to identify, isolate and remediate problems in cold-chain shipping.

### SUMMARY OF THE INVENTION

The present invention describes systems and methods for use with frozen or deep-frozen cryogenic shipping containers used to transport commodities, including shipment of various commodities such as live cell bio-commodities, vaccines, tissues, etc., and various methods for monitoring and controlling shipments of commodities using an integrated packaging and monitoring system. A method is provided for monitoring the status and sufficiency of the Thermal Source which is integrated with the design of the shipping container so as to provide resistance to shock and vibration as well as an additional source of thermal insulation.

According to an aspect of the description, a container that may be used in shipping comprises an inner space and/or enclosure (referred to interchangeably as “inner enclosure” or “inner space”) to carry a Thermal Source and one or more commodities during shipment, at least one transducer configured to determine weight of the inner space and/or enclosure, the Thermal Source and the one or more commodities, and a processor that may include a processor such as a processing device configured to receive measurements from the at least one transducer, and to communicate the measurements to a networked device upon detecting the presence of a network, wherein the measurements include a current weight of contents or an inner space and/or of the shipping package. The weight of the inner enclosure may include the weight of the one or more commodities, packaging and the Thermal Source. Knowing the weight of the shipping package, the inner container, the Thermal Source and the commodities contain within, the current weight of the Thermal Source may be determined as the difference between the initial weight of the inner enclosure and a current weight of the inner enclosure. Using formulae derived from prior analysis of the rate of depletion of the Thermal Source including consideration of the effects external forces known to affect the rate of depletion of the Thermal Source such as cumulative time-in-transit, periods of rest, movement, shock, vibration, tilt, temperature and humidity, a shipper can determine a priori if the projected remaining life of the Thermal Source will be sufficient to maintain desired temperatures until the shipping container reaches its final destination.

According to an aspect of the description, the processing device, a network or cloud-hosted application processes the measurements. The networked or cloud-hosted device may transmit a command to the processing device that causes the processing device to adjust a configuration parameter. The configuration parameter may configure one or more of a sensor sample interval, a preferred network communication route, an allowed or prohibited network communication route, and a remote control of an annunciator provided on the shipping container.

According to an aspect of the description, the processing device may be configured to determine a location of the shipping container based on the presence or absence of network infrastructure. The network infrastructure may comprise one or more processing devices associated with other shipping containers. The processing device may be configured to determine a location of the shipping container based on absence or presence of shipping scan-codes received from the carrier that are associated with the shipping container or from other parameters such as outside temperature, a sound frequency, altitude, absence or presence of a network, and time-in-transit. The processing device may be configured to determine a location of the shipping container based on coordinates derived from a GPS signal. The shipping container may be determined to be located within a structure when no GPS signal is detected.

According to an aspect of the description, information transmitted by the processing device is fused with data received from a customer or carrier, wherein the data includes one or more of custody transfer, time, state and weight information and networks detected along a shipping route.

According to an aspect of the description, at least one bladder may be conformed to the inner surface of the inner chamber and instrumented with the at least one transducer. The at least one bladder may comprise a plurality of segments, each segment maintaining a uniform pressure such that vectors of arrival of the shock and vibration is perpendicular to the one or more commodities. Each of the at least one transducer may measure the pressure of at least one segment of the bladder.

According to an aspect of the description, the at least one bladder conformed to the inner surface of the inner chamber may have a shape adapted to provide protection of the Thermal Source and the one or more commodities or other materials.

According to an aspect of the description, a band may be configured to maintain the at least one bladder in a desired position. The at least one transducer may include a strain gauge configured to measure the stress load of the band in response to the pressure of the bladder or bladder segment, the stress load being indicative of the weight of the Thermal Source. The stress load may measure differential pressure between at least a segment of a bladder and external atmospheric pressure. The differential pressure may be indicative of the weight of the Thermal Source. One or more of a change detected in radio frequency environment, an absence or presence of a network, the differential pressure, a vibration, an acceleration and a tilt may be used to determine if the shipping container is on an aircraft or other vehicle. Pressure measurements may be based on an evaluation of tilt or orientation of the shipping container in relation to the center of the earth. The bladder may comprise a material or mesh having elastic properties that limit volumetric expansion, thereby assuring accurate pressure measurement. The measurement of the stress load of the band may be used to determine the weight of the one or more commodities. The at least one bladder may absorb shock and vibration and provide thermal insulation.

According to an aspect of the description, the at least one transducer may be coupled to a plate located under the inner enclosure. The at least one transducer may comprise a microelectromechanical system (MEMS) device or a similar device capable of measuring stress or load.

### BRIEF DESCRIPTION OF THE DRAWINGS

FIG. 1 illustrates a shipping container adapted according to certain aspects of the invention.

FIG. 2 illustrates a smart module according to certain aspects of the invention.

FIG. 3 illustrates network access by a smart module according to certain aspects of the invention.

FIG. 4 illustrates a shipping container adapted according to certain aspects of the invention.

FIG. 5 illustrates a shipping container adapted according to certain aspects of the invention.

FIG. 6 is a flowchart illustrating a method of using a shipping container adapted according to certain aspects of the invention.

FIG. 7 is a simplified block schematic illustrating a processing system employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the descriptions herein are intended to encompass other embodiments including a plurality of the same component, and vice-versa, unless explicitly stated otherwise. Moreover, applicants do not intend for any term in the specification or claims to be ascribed an uncommon or special meaning unless explicitly set forth as such. Further, embodiments of the present invention encompass present and future known equivalents to the components referred to herein by way of illustration.

Certain embodiments of the invention enable gathering of data from a shipping container during shipment. The data may include information related to external forces such as shock, vibration and tilt observed at the shipping container or to the contents contained therein, and environmental conditions surrounding the container such as temperature and pressure experienced by the container during shipment. The data may include location information associated with the container, including one or more locations of the container during shipment that may be determined using one or more of RFID detection, MAC-address association, GPS or RF presence sensing, carrier scan-codes, RF triangulation or trilateralization. The data may be used to determine if the remaining life of a Thermal Source associated with the container is sufficient to provide protection until the planned delivery of the container at its destination, with sufficient margin to cover unexpected delays. If it is determined a priori that the remaining life of the Thermal Source is insufficient, the data may be used to trigger an intervention measure to cause the shipment to be intercepted in order to replenish the Thermal Source, before delivery of the shipping container to the final destination or to direct it an alternate destination where the replenishment of the Thermal Mass can be accomplished with less delay.

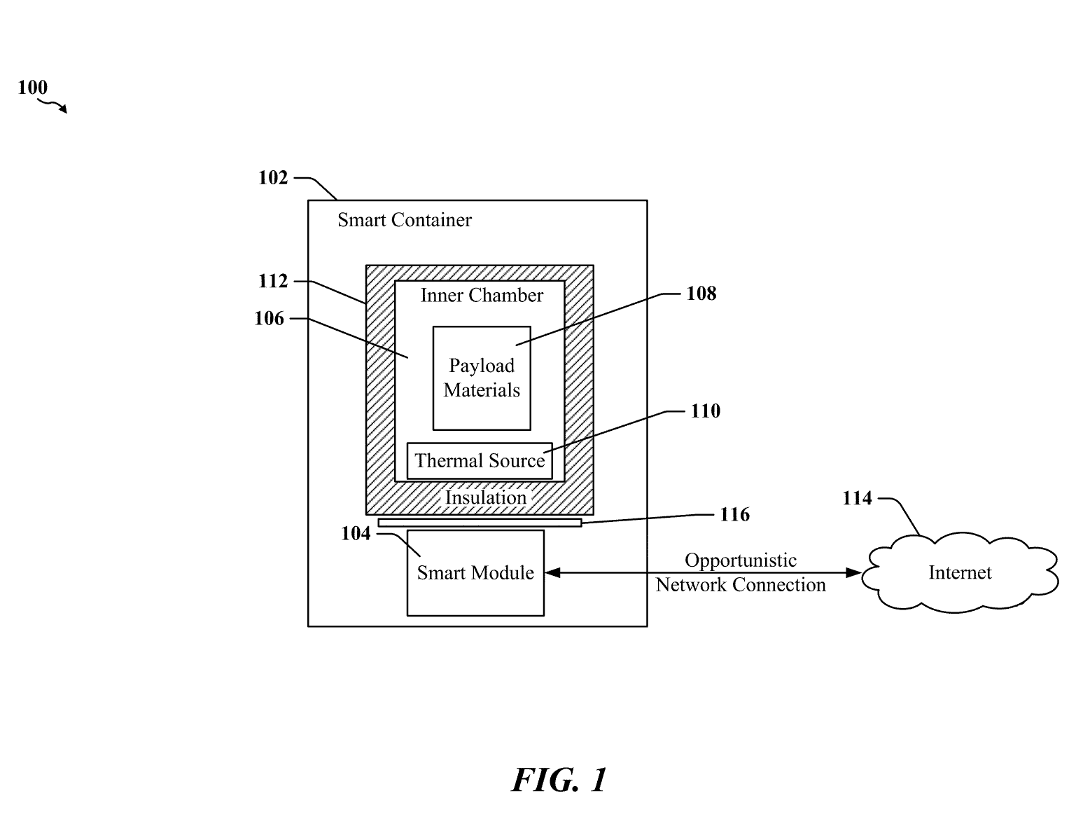

FIG. 1 is a block diagram 100 illustrating a smart shipping container 102. For the purposes of this description, a smart shipping container or shipping container 102 (interchangeably referred to herein as “the Shipping Container”) may comprise a package, box or other container utilized for the transport of commodities or commodities 108 as a payload under temperature stabilized conditions. The Shipping Container 102 may comprise more than one container such as a Dewar, or an inner enclosure 106. The Shipping Container 102 may comprise a single enclosure having an inner space that may be insulated. Certain principles described herein apply equally to a Shipping Container 102 that employs an inner enclosure 106 and one that has only and inner space (e.g. a shipping box). The Dewar, inner enclosure 106 and/or inner space may form an insulated or non-insulated containment volume configured to maintain commodities under temperature stabilized conditions. A Dewar, inner space or inner enclosure 106 may be enclosed by an outer container or shell, which may include a layer of insulation 112. In at least some embodiments, the Shipping Container 102 contains a phase-change material 110 such as dry-ice, gel-packs or liquid nitrogen and commodities.

In certain embodiments, a Smart Module 104 and/or one or more transducers or sensors may be attached or inserted within the Smart Container 102. Smart Module 104 may be configured to communicate opportunistically with a network such as the Internet 114 or to another network that may be accessed through a mobile access point, which may be attached to or carried by a person, animal or vehicle for example. The contents of the Smart Container 102, comprising the Thermal Source 110, commodities and/or specimens 108, and the Smart Module 104 may be co-located within the Smart Container 102 such that the contents rest upon a plate 116 or bladder (not shown) allowing the weight of the contents to be measured by means of a transducer coupled to the plate 116 or from a measurement of pressure within the Bladder.

In certain embodiments, the Shipping Container 102 is adapted or adaptable to carry commodities such as pharmaceuticals, vaccines, tissue samples, cell-lines, specimens, sera, synthetic or radioactive commodities, etc. Commodities transported by the Shipping Container 102 may be referred to herein as Commodities.

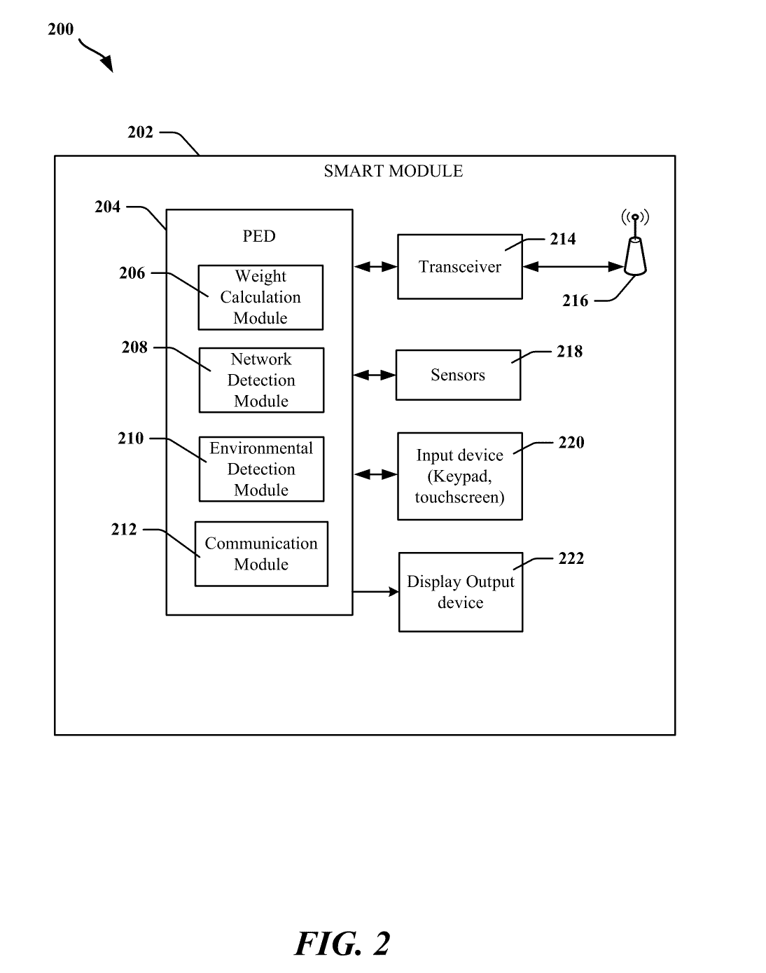

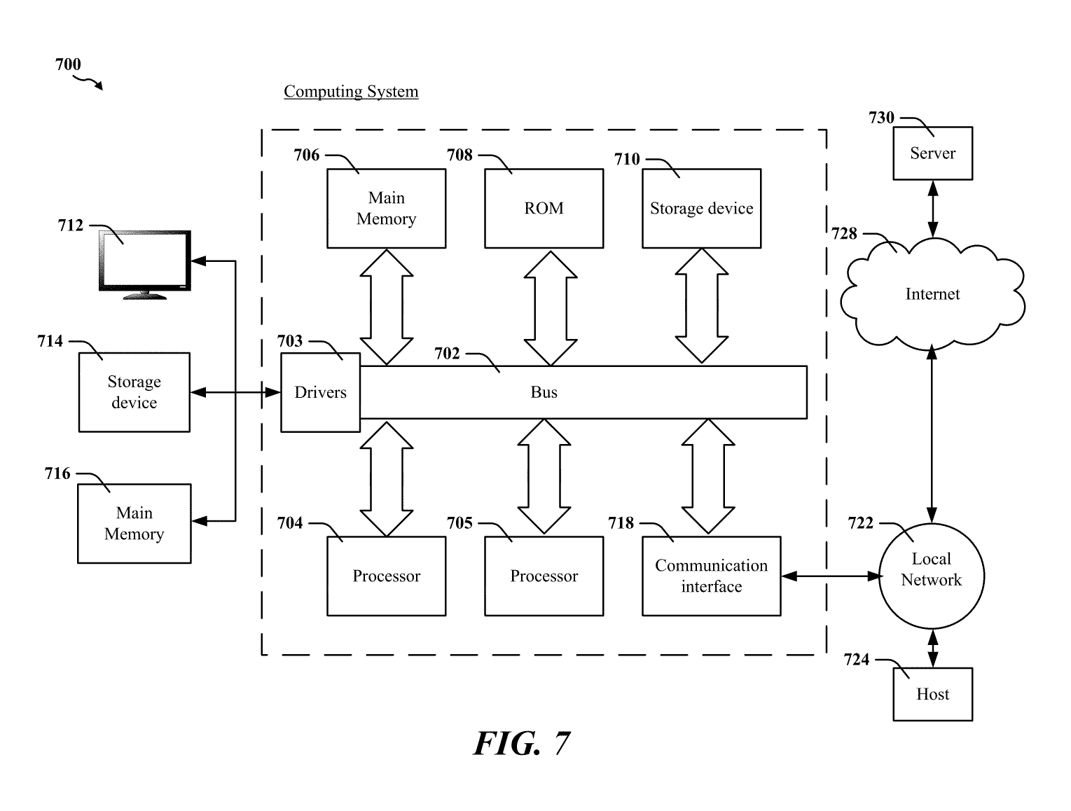

With reference also to FIG. 2, Smart Module 202 may be configured to connect to a network 216 by any available means. For the purposes of this description, a Smart Module 202 may comprise a processing circuit such as programmable electronic device (PED) 204. PED 204 may have some of or all of the elements shown in FIG. 7 and described in more detail below. PED 204 may include one or more of a power source, a display, a CPU, non volatile storage, a light emitting diode (LED) lamp or indicator, a button or switch, an aural alarm indicator, a radio frequency or optical or infrared transmitter and/or receiver, a global positioning system receiver, and analog-to-digital (A/D) converter, and a digital-to-analog converter (D/A). PED 204 may include or be coupled to a sensor or multiple sensors 218. The sensors 218 may comprise transducers that can be used to sense or measure pressure, acceleration, temperature, humidity, magnetic field, light, load, inclination, radio frequency identification (RFID) signals and or RFID return signals, whether related to a passive or active RFID tag. PED may additionally comprise a battery or energy scavenging device and a wired, wireless, infrared, or magnetically coupled interface 214 that is coupled to an antenna 216 used for communications.

A Smart Module 202 may be added to the Shipping Container 102 to obtain a Smart Shipping package, which comprises a, cooled insulated package that monitors and reports status of a Thermal Source 110, package condition and location and that monitors, records and tracks significant events associated with a Smart Shipping package. Smart Module 202 may employ sensors 218 and one or more RF transceivers 214 that enable tracking the Shipping Container 102 while in transit. One or more RF transceivers 214 may respond to interrogation by networks encountered at various points while in transit. The one or more RF transceivers 214 may communicate and/or be associated with a plurality of distinct networks, rather than associating with a single logical network through a single login credential. In one example, the RF transceivers may transmit and receive data over any available network, including a plurality of different networks using different credentials.

The RF transceivers 214 may interrogate or otherwise initiate communication through networks encountered at various points while in transit. The Smart Module 102 may be interrogated by one or more devices connected to a network 114 upon establishment of connection between the Smart Module 202 and the network 114. The Smart Module 202 may also proactively transmit information through the network 114 upon determining presence of a suitable access point or access network and negotiating a connection with the access point or access network. The Smart Module 202 may transmit information using standard and proprietary network protocols in a connection-based or connectionless mode of operation. The Smart Module 202 may use telecommunication networks to send, for example, short messages and/or units of data.

The Smart Module 202 may refrain from communicating based on its location or mode of transit. In one example, the Smart Module 202 may suspend communication activities when it determines that the Shipping Container 102 is located aboard an airplane, during take off and landing, for example, The determination to refrain or recommence communication may be made based on an analysis of elapsed time, location, in response to monitored sensor inputs (temp, altitude, vibration, vibration, RF frequency detection, noise identifiable as speech, jet engines, machinery etc., absence of GPS signals when indoors, exposure to magnetic fields, orientation, presence or absence of (i) light or lighting with detectable characteristics (i.e. Kelvin), or absence thereof, and (ii) by external commands provided via magnetic, infrared or RF communications, and/or the detection of certain RF frequencies or determination of the presence or absence of a certain network address.

The Smart Module 202 may determine location of the Shipping Container 102 may be determined at various points during transit. A monitoring system may determine or infer the location of an object by correlating identifiable information in a wireless emission or transmission such as RF, infrared, magnetic, electromagnetic and other media, which is associated with a known and previously determined location. This may be accomplished by means of a single received transmission and/or by a series of related and/or unrelated emissions and/or transmissions. The Smart Module 202 may further determine or infer the location of an object by correlating scan code information provided by handlers of the Shipping Container 102 or by third parties. Scan code information typically comprises actual location information or location identifications made by inference or deduction from scan code information and/or the fusion of scan code information with other sensor or network information.

The Smart Module 202 may determine or infer the location of the Shipping Container 102 using GPS, by RFID “readers” or purposefully placed beaconing transmitters at pre-positioned “choke points” and/or by cellular network triangulation. The Smart Module 202 may determine or infer the location of an object within a building or finite area by means of an analysis of Received Signal Strength Indications (RSSI) or Time Differential of Arrival (TDOA) from one or more transceivers.

The Smart Module 202 may determine or infer the location of the Shipping Container 102 using an estimate of where the object should be based on the time elapsed since the Shipping Container 102 departed its point of origin. The Smart Module 202 may determine or infer the location of the Shipping Container 102 by observing the number of “hops” and duration of each hop, in a shipment as defined by a barometer detecting ascension to altitude.

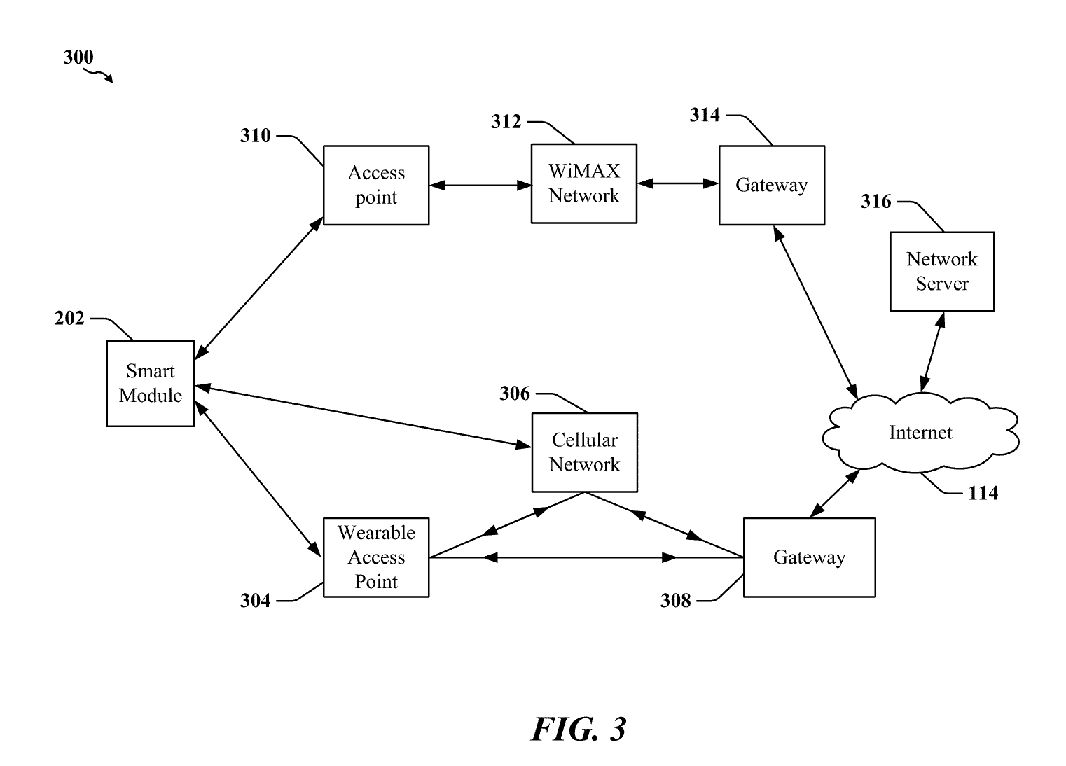

With reference also to FIG. 3, The Smart Module 202 may exchange data with networked entities 316 using one or more networks 114 encountered while in transit. The process of information gathering or data harvesting from one or more Smart Modules 202 may be referred to herein as “data backhaul.” Data may be harvested by means of a continuous wireless network (WLAN) connection such as GPRS or other cellular network 306, and/or a WiMAX network 312, and/or through purpose-built data collection agents placed in third party (e.g. customer or partner) locations and at strategic “choke-points” along the route of a shipping lane.

Data may be harvested using access points 310, peer devices 304 and other opportunistic network connections. Opportunistic harvesting may occur (i) when the object senses the availability of a temporary or transient local area network (LAN) or personal area network (PAN) agents 304 at any time during their journey, (ii) when two or more objects exchange information among each other (ad-hoc) such that the first object that reaches a network connection uploads information from all other objects it encountered in its journey, and (iii) through mobile data collection agents which come in proximity to an object. Mobile data collection agents may be purposefully mounted on a vehicle or worn by a person or animal. In one example, the location of a Smart Container 102 may be known and its logs offloaded through body-worn access points and/or worker cell phones enabled for opportunistic networking.

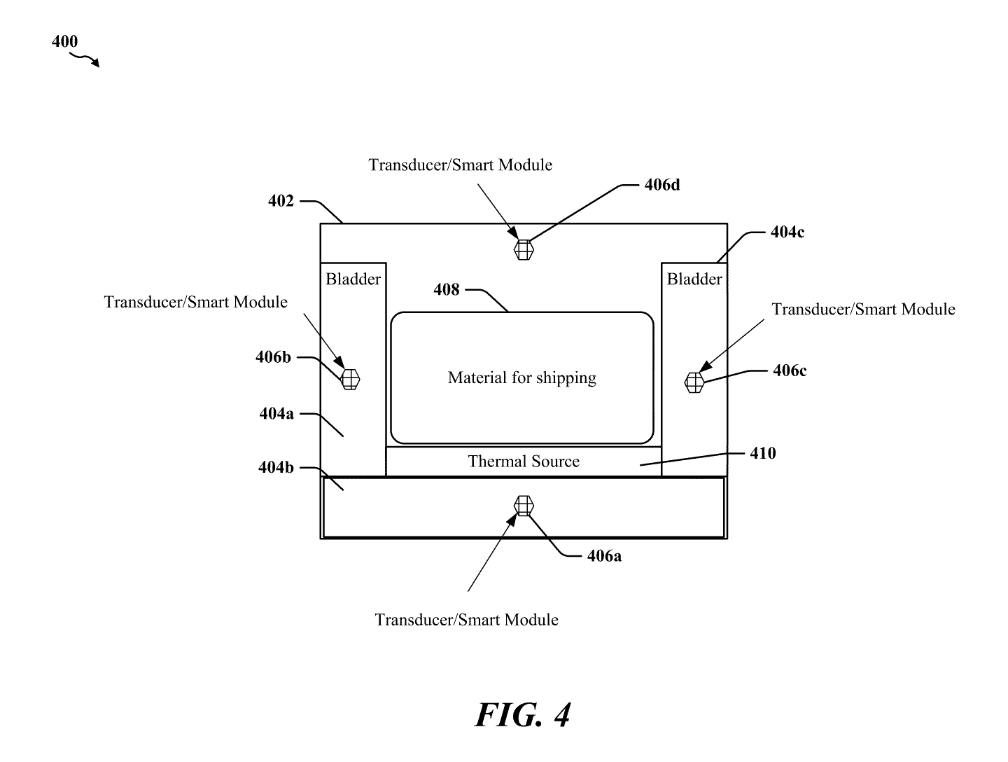

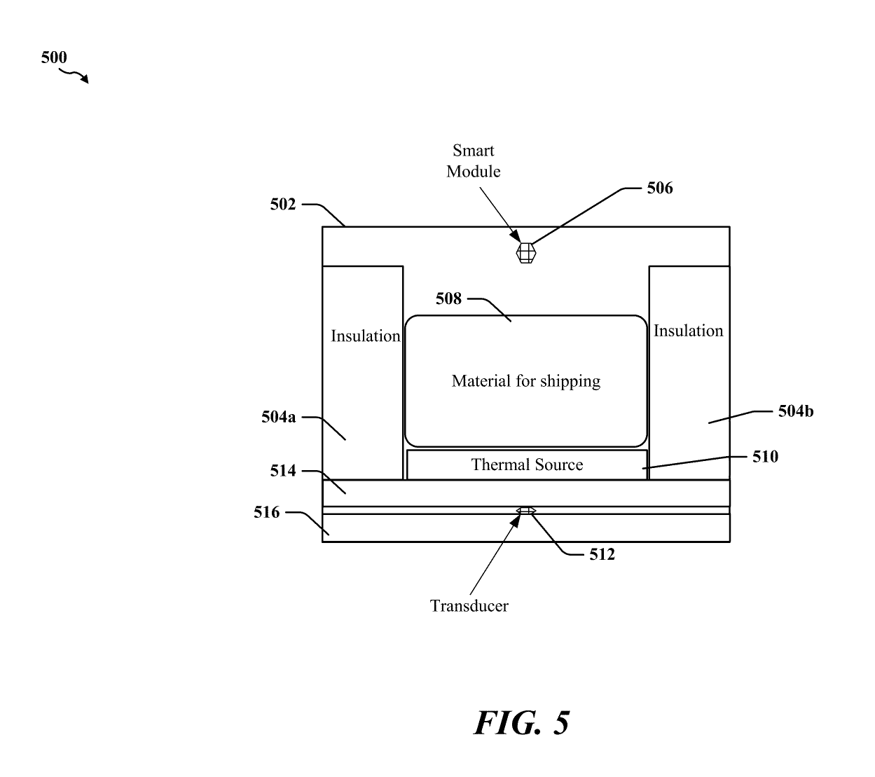

FIGS. 4 and 5 illustrate configurations of a Smart Container 402 or 502 that provide apparatus and methods for measuring weights of commodities 408, 508 and/or Thermal Sources 410, 510 in an inner enclosure, which maybe surrounded insulation 504a, 504b and/or one or more bladders 404a, 404b, 404c. In certain embodiments, the Shipping Container 102 may comprise a weight transducer 512 that can be used to measure the status of a Thermal Source 510 used to maintain the temperature of the contents at a desired level. In one example, one or more Smart Bladders 404a, 404b, 404c may be employed. The Bladders 404a, 404b, 404c may comprise a pressurized package, vessel or balloon-like device of various size, shapes and configuration which may be instrumented using one or more sensors coupled to a Smart Module 406a, 406b, 406c, 406d, which may be provided internal, partially internal, or entirely external to the Bladders 404a, 404b, 404c. The pressure detected in the bladders 404a, 404b, 404c may indicate a current weight of the package, including the Thermal Source 410 and the difference from initial weight may be used to determine the expected remaining life of the Thermal Source 410.

The weight of the inner enclosure may include the weight of the one or more commodities 408, 508 and the Thermal Source 410, 510. A current weight of the Thermal Source 410, 510 may be calculated as the difference between the initial weight of the inner enclosure and a current weight of the inner enclosure. The weight calculation may include compensation for orientation and tilt of the container 402, 502, as well as ambient temperature and external air pressure. More than one bladder 404a, 404b, 404c may be provided to accommodate different orientations and tilts.

In another example, electromechanical and/or electromagnetic transducers 512 may be employed to determine the current weight of the package, and allow a calculation of remaining life of the Thermal Source by module 206. Transducers may be provided around the container 402, 502 to allow the weight to be measured regardless of orientation of the devices and/or tilt of the package.

In another example, the 502 may be fitted with a load cell 512 constructed using a MEMS device deployed between two rigid walls or plates 514, 516 that may be fabricated from a polymer, metal or suitable material, located in the bottom of a container. Accordingly, at least one wall or plate 514, 516 is located under the Thermal Source and can be measured by a transducer coupled to one or more of the at least one wall or plate 514, 516. Commodities to be shipped 508 and a phase-change material 510 such as dry ice may be placed in the container 502. Given the weight of the container when empty and the weight of the commodities, the weight of the phase-change material 510 can be calculated by simple arithmetic. Adjustments may be made based on orientation and/or tilt.

Certain embodiments comprise a Thermal Source 410, 510 which may include a phase change material, a catalytic material, a mechanical device, and electro-mechanical system or other material or device which provides or removes thermal energy from the Shipping Container 402, 502 or an inner enclosure of the Shipping Container 402, 502 to heat or cool the Commodities or commodities 508 carried by the Shipping Container 402, 502.

Certain embodiments of the invention can stabilize temperature by maintaining a specific range of temperature in the Shipping Container or an inner enclosure of the Shipping Container using a Thermal Source and a means of insulating the contents from the forces of the environment. In one example, the Shipping Container may be at least partially wrapped in a thermally non-conductive material. In another example, the Shipping Container may comprise one or more layers that are thermally non-conductive. In another example, the Shipping Container may comprise an interstitial space that encloses a gas, a low-pressure gas and/or a vacuum. Temperature stabilization may be employed to store Commodities at, above, or below a targeted temperature range. When used for maintaining a predefined ambient or near-ambient temperature, the shipping container may rely on thermal mass to accomplish temperature stability. In certain embodiments, the Shipping Container may be shipped through the services of a carriage, transportation or overnight shipping company or by a third-party logistics provider.

Every year approximately 60 million parcels are shipped through domestic and international carriers to end-points around the world, each containing sensitive and valuable commodities. Almost all carriers offer extra-cost services to track, monitor and manage these shipments which frequently require special handling to protect their contents and require special documentation or export/import licenses.

Many government entities and agencies, such as the United States Food and Drug Administration (FDA), provide indirect control and supervision over the manufacture, shipping, storage and distribution of regulated products by requiring each manufacturer to develop and maintain FDA approved standard operating procedures (SOPs). SOPs prescribe the steps, sequences, methods and actions that will be employed by the manufacturer and their business partners to assure the proper handling, storage and distribution of regulated products. The SOP development process necessarily requires “proof” through documented testing proving that the prescribed methods and procedures contained within the SOP will result in the delivery of Commodities that are safe and effective and not otherwise damaged or degraded due to improper manufacture, handling or storage and distribution.

The FDA considers conformance to SOPs a matter of important public policy contributing to the health and safety of our health care system. Accordingly, there are many regulations published by FDA and other government or quasi-government agencies to enforce standards and “best-practices” on the shipment of temperature stabilized commodities. Manufacturers of regulated products whose manufacturing, shipping, storing or distribution activities fail to conform to FDA approved SOPs are subject to fines, or in extreme cases, revocation of previously granted approvals.

Although the research activities including the shipment of commodities used in research are exempt from government regulation, many non-regulated companies comply or partially comply with industry best practices relating to temperature stabilized commodities in order to reduce risk and uncertainty in research and product development process. Taken all together, the market for the shipment of temperature stabilized commodities is large, and exposes companies involved in the process to high cost and risk. Certain aspects of the invention reduce the risk of inaccurate test results, fines and the high cost of specialized packaging and services, and provide systems and methods for transporting commodities at less cost and with more predictability and reliability.

For the purposes of this discussion, it will be assumed that shipping companies such as Federal Express, DHL, United Parcel Service (UPS), World Courier, offer specialty extra-cost services to assist manufacturers and distributors with conformance with SOPs. Aspects of the current invention supplement or replace shippers shipping and logistics processes, and address the unique requirements of cold-chain shipping.

The transport of temperature stabilized commodities involves risk, uncertainty and high cost. The risk and uncertainty are attributable to the inability of shippers to monitor the condition and status of the shipment and the health of the commodities contained therein, once it is placed in the hands of a shipping company. High costs are incurred when the commodities in a temperature stabilized shipping container are damaged or lost due to environmental conditions such as shock or loss inability to maintain a desired temperature.

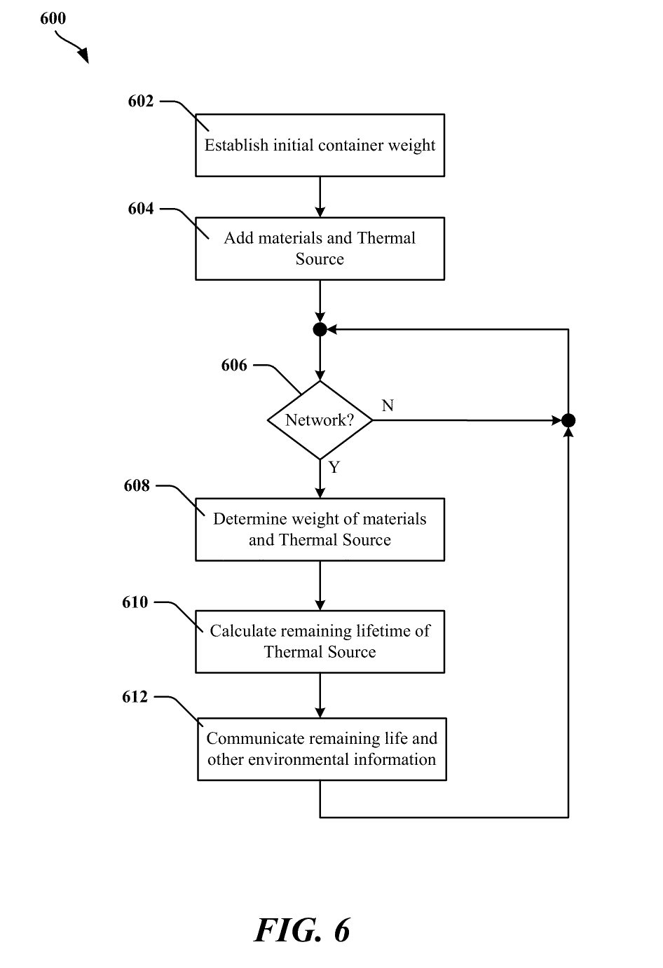

FIG. 6 is a flowchart 600 that illustrates a process performed by PED 204 of Smart Module 202. At step 602, circuit or module 206 may determine the initial weight of the container 102 using one or more sensors 218. At step 604, the container 102 may be loaded with material 108 and Thermal Source 110.

At step 606, the Smart Module 202 may determine the presence of one or more networks using circuit or module 208, transceiver 214 and antenna 216. At step 606, the Smart Module 202 may determine, in response to, or advance of, the detection of a network, the current weight of the commodities 208 and Thermal Source 210. At step 210, the Smart Module 202 may calculate the remaining lifetime of the Thermal Source 210. At step 612, the Smart Module 202 may communicate environmental information including the remaining life of the Thermal Source 612 to a network entity 316

Aspects of the present invention enable the provisioning of smart shipping containers, which may comprise a specialized packaging coupled with electronics that combine an optimized packaging solution with features of tracking, sensing, communications, insulation and shock absorption properties into a single integrated packaging and shipping solution. Aspects of the present invention provide the means for a shipper to monitor the health, condition and remaining useful life of the Thermal Source and commodities while in the custody of a carrier.

Certain embodiments of the invention comprise a Shipping Container that has a pressure-filled bladder or vessel configured to have a specific shape, size and volumetric capacity to conform to the shape of the Shipping Container or an inner enclosure of the Shipping Container. The Bladder is typically provided on the bottom, top or sides of the Shipping Container. Commodities and a Thermal Source may be placed on top or within the envelope of the Bladder for shipment.

The bladder may have shock absorption and insulation properties sufficient to protect the Commodities carried within the Shipping Container. The Bladder may be instrumented using a wireless programmable electronic device adapted to determine the weight of the Thermal Source through translation of pressure forces exerted on upon the bladder by the Thermal Source and/or the Commodities carried within the Shipping Container. In one example, a change in the measured weight of the Shipping Container, Commodities and thermal mass may be attributable to decreased mass of the Thermal Source. Through repeated measurements and simple arithmetic calculation, the mass of any remaining Thermal Source can be calculated and tracked over a period of time. The mass of the remaining Thermal Source can be used to determine one or more of the effectiveness of the Thermal Source, the condition of the Commodities and the probability that the remaining Thermal Source material will be sufficient to maintain a desired level of temperature stabilization at or until the time of delivery or expected time of delivery, and/or for a time period after delivery or after expected time of delivery due to unanticipated delays in the shipping process.

In some embodiments, determination of effectiveness of Thermal Source can be made based on remaining mass of the Thermal Source, rate of decline of thermal mass and/or environmental conditions such as shock, vibration and tilt experienced by the Shipping Container. Knowledge of the state of the Thermal Source may prevent damage or loss of the Commodities shipped in the Shipping Container. For example, if a shipper knows a priori that the remaining mass (of dry ice or liquid nitrogen, for example), or energy of a Thermal Source was insufficient to provide temperature stabilization until the date of planned or expected delivery of the container plus a reasonable margin, the shipper may be able to arrange to have the Shipping Container intercepted during shipment in order to take corrective action.

In one embodiment of the invention, the bladder is placed in the bottom of the Shipping Container. The known weight of the Commodities added to the Shipping Container may be recorded and/or measured along with the weight of the Thermal Source such as dry ice or liquid nitrogen placed within the shipping container. While enroute, the weight of the Thermal Source can be determined by sensors coupled to the bladder and reported via a wireless network. The information captured by the sensors may be used to calculate remaining mass and useful life of the Thermal Source. Calculations may be made by a Smart Module attached to the Shipping Container and/or by a computing system that receives measurements and other information from the Shipping Container, typically through a network such as the Internet.

Certain aspects of the invention can assist enterprises, corporation, individuals and other entities to reduce shipping costs by providing data about the environmental conditions that the Shipping Container has been exposed to during shipment. In addition, the bladder may provide increased shock absorption and insulation. The bladder may enable shippers to programmatically determine the amount of thermal energy remaining in a temperature stabilized Shipping Container using ad-hoc or deterministic remote communications.

Certain aspects of the invention may reduce risk and shipping costs by providing systems and methods for gathering data from a Shipping Container during shipment. The data includes information about the forces (shock, vibration and tilt) and environmental factors (temperature and pressure) that the Shipping Container has been exposed to during shipment. The data can be used to determine if the remaining life of the Thermal Source is sufficient to provide protection until the expected date/time of delivery plus a margin.

Certain aspects of the invention may reduce risk and shipping costs by providing a low-cost re-usable shock absorption and insulative solution that is green and not hazardous. Certain aspects of the invention may reduce risk and shipping costs by providing a means to determine the location of the shipment using RFID, MAC-address association, GPS or RF presence sensing, carrier scan codes, RF triangulation or trilateralization.

Certain embodiments of the invention provide a smart shipping container. Some embodiments comprise a smart module, smart bladder and may be configured to carry one or more commodities.

In some embodiments, an electronic device is attached or otherwise coupled to the bladder. The electronic device may comprise a smart module configured to communicate monitored parameters to a network and through the network to a server or one or more cloud-resident applications. In some embodiments the monitored parameters and other information may be processed and analyzed by the applications. In some embodiments, a cloud or server application can send a command back to the package to adjust configuration parameters or to determine if its location has changed. Configuration parameters may comprise sensor sample intervals, preferred, allowed or prohibited routes for network communications, and remote control of annunciators or visual media such as LED, or LCDs on the Smart Module or Shipping Container.

In some embodiments, the smart module may determine its location by reference to detected network infrastructure in the area. In some embodiments, the smart module may determine its location by detection or communication with other Smart Modules RF or RFID transmitters that may be present or absent nearby. In some embodiments, the smart module may determine its location by the absence or presence of Carrier generated shipping scan-codes received and processed by application servers. In some embodiments, the smart module may determine its location by through GPS derived coordinates, or through inference of other factors such as outside temperature, sound frequencies, vibration or inclination patterns, presence or absence of carrier scan codes, altitude or time-in-transit.

In some embodiments, the smart module may form a mesh network with other smart modules to extend communications range, improve throughput or share, compare or exchange data among themselves or with applications servers. In some embodiments, the smart module may issue a local auditable or visual alarm when any measurement or any condition observed is deemed critical or threatening to the protection of the commodities.

In some embodiments, data received from a smart module may be fused with data received from carriers such as custody transfer, time, state and weight information. New information may be inferred from the merged data to improve the accuracy of location or delivery information, the health and status of the shipping container itself or the predictions and confidence of such predictions into the future.

In some embodiments, the bladder has an intelligent shape to conform to the contours of the smart shipping container or an inner enclosure or container that contains or carries commodities. In some embodiments, the intelligent shape of the bladder maximizes protection of the Thermal Source and commodities from external forces known to affect or cause an accelerated loss of energy by the Thermal Source. In some embodiments, the design and shape of the bladder minimizes the movement of the inner enclosure or container and/or the commodities.

In some embodiments, the design and shape of the bladder can accommodate protrusions from a Dewar such as handles or fill tubes and may contain other design features such as pockets to hold commodities, accessories and documentation. The bladder may be provided with one or more smart modules, each measuring the pressure of one bladder segment. In some embodiments, one smart module may measure the pressure of all bladder segments.

In some embodiments, the bladder may comprise one or more windows, placed within the bladder to permit visual inspection of objects surrounded by the bladder. In some embodiments, the bladder and smart shipping container may have a clamshell design comprising an upper section and a lower section to facilitate assembly or as a means of improving the accuracy of the bladder segmentation strategy which results in improved accuracy of physical measurements.

In some embodiments, a band placed around the bladder may maintain the bladder in a desired position. The band may also contain a strain gauge to measure the strain or stress load of the band which varies depending on the weight of the Thermal Source. The measurement of the stress load of the band is used to determine the weight of commodities but more importantly the Thermal Source.

In some embodiments, the bladder absorbs shock and vibration and protects the commodities. The bladder can be multi-segmented, each segment maintaining a uniform pressure such that the vector arrival of shock or vibration is perpendicular to the stored commodities and shipping container. In some embodiments, differential pressure, the pressure inside the bladder or bladder segment and the atmospheric pressure outside the bladder, is used to adjust pressure measurements due to changes in atmospheric pressure. In some embodiments, differential pressure may also be used to calculate altitude by fusing sensor information such as acceleration and barometric to determine if the smart shipping container is located in an airplane, for example.

In some embodiments, the bladder the smart module determines which bladder or bladder segment is capable of providing the most accurate pressure measurement based on the evaluation of its tilt or orientation in reference to the center of the earth. In some embodiments, the bladder the smart bladder comprises a material or mesh having elastic properties that limit volumetric expansion thereby assuring an accurate pressure measurement for any varying amount of weight placed upon it.

In some embodiments, remaining thermal energy or energy potential of the Thermal Source is determined by periodically determining the current weight of the Thermal Source during the shipping process. In some embodiments, the current weight is determined by taking a pressure measurement at a point in time when the weight of the Thermal Source is perpendicularly aligned with the bladder or bladder segment. The alignment may be determined by evaluating information from other sensors or the pressure in other segments of the bladder or by evaluating the tilt, or orientation of the package position relative to the center of the earth. In some embodiments, algorithms may be employed to calculate weight if the smart shipping container is not perfectly aligned with the center of the earth.

In some embodiments, the bottom surface of the bladder is designed to provide optimal surface contact with and orientation to the bottom of the smart shipping container in order to achieve a reliable pressure measurement for any given amount of tilt or inclination. Another embodiment of this concept might apply to the sides and top of the smart shipping container so that an accurate weight measurement can be achieved for any given amount of tilt or inclination.

### System Description

Turning now to FIG. 7, certain embodiments of the invention employ a processing system that includes at least one computing system 700 deployed to perform certain of the steps described above. Computing systems may be a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system, for embedding in a shipping container. In one example, computing system 700 comprises a bus 702 and/or other mechanisms for communicating between processors, whether those processors are integral to the computing system 700 (e.g. 704, 705) or located in different, perhaps physically separated computing systems 700. Device drivers 703 may provide output signals used to control internal and external components

Computing system 700 also typically comprises memory 706 that may include one or more of random access memory (“RAM”), static memory, cache, flash memory and any other suitable type of storage device that can be coupled to bus 702. Memory 706 can be used for storing instructions and data that can cause one or more of processors 704 and 705 to perform a desired process. Main memory 706 may be used for storing transient and/or temporary data such as variables and intermediate information generated and/or used during execution of the instructions by processor 704 or 705. Computing system 700 also typically comprises non-volatile storage such as read only memory (“ROM”) 708, flash memory, memory cards or the like; non-volatile storage may be connected to the bus 702, but may equally be connected using a high-speed universal serial bus (USB), Firewire or other such bus that is coupled to bus 702. Non-volatile storage can be used for storing configuration, and other information, including instructions executed by processors 704 and/or 705. Non-volatile storage may also include mass storage device 710, such as a magnetic disk, optical disk, flash disk that may be directly or indirectly coupled to bus 702 and used for storing instructions to be executed by processors 704 and/or 705, as well as other information.

Computing system 700 may provide an output for a display system 712, such as an LCD flat panel display, including touch panel displays, electroluminescent display, plasma display, cathode ray tube or other display device that can be configured and adapted to receive and display information to a user of computing system 700. Typically, device drivers 703 can include a display driver, graphics adapter and/or other modules that maintain a digital representation of a display and convert the digital representation to a signal for driving a display system 712. Display system 712 may also include logic and software to generate a display from a signal provided by system 700. In that regard, display 712 may be provided as a remote terminal or in a session on a different computing system 700. An input device 714 is generally provided locally or through a remote system and typically provides for alphanumeric input as well as cursor control 716 input, such as a mouse, a trackball, etc. It will be appreciated that input and output can be provided to a wireless device such as a PDA, a tablet computer or other system suitable equipped to display the images and provide user input.

According to one embodiment of the invention, processor 704 executes one or more sequences of instructions. For example, such instructions may be stored in main memory 706, having been received from a computer-readable medium such as storage device 710. Execution of the sequences of instructions contained in main memory 706 causes processor 704 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 704 and/or 705, particularly where the instructions are to be executed by processor 704 and/or 705 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 704 and 705 or remotely, typically by use of network connection. Non-volatile storage may be removable from computing system 704, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 700. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 704 and/or 705. For example, the instructions may initially be retrieved from a magnetic disk of a remote computer and transmitted over a network or modem to computing system 700. The instructions may optionally be stored in a different storage or a different part of storage prior to or during execution.

Computing system 700 may include a communication interface 718 that provides two-way data communication over a network 720 that can include a local network 722, a wide area network or some combination of the two. For example, an integrated services digital network (ISDN) may used in combination with a local area network (LAN). In another example, a LAN may include a wireless link. Network link 720 typically provides data communication through one or more networks to other data devices. For example, network link 720 may provide a connection through local network 722 to a host computer 724 or to a wide area network such as the Internet 728. Local network 722 and Internet 728 may both use electrical, electromagnetic or optical signals that carry digital data streams.

Computing system 700 can use one or more networks to send messages and data, including program code and other information. In the Internet example, a server 730 might transmit a requested code for an application program through Internet 728 and may receive in response a downloaded application that provides for the anatomical delineation described in the examples above. The received code may be executed by processor 704 and/or 705.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a container that may be used in shipping. In certain embodiments the container comprises an inner enclosure adapted to carry one or more commodities during shipment. In certain embodiments the container comprises a bladder conformed to the inner surface of the inner chamber and instrumented with at least one transducer. In certain embodiments the container comprises a processing device configured to receive measurements from the at least one transducer, and to communicate the measurements to a networked device upon detecting the presence of a network.

In some of these embodiments, the networked device processes the measurements using a cloud-resident application. In some of these embodiments, the networked device transmits a command to the processing device that causes the processing device to adjust a configuration parameter. In some of these embodiments, the configuration parameter configures one or more of a sensor sample interval, a preferred network communication route, an allowed or prohibited network communication route, and a remote control of annunciators provided on the shipping container.

In some of these embodiments, the processing device is configured to determine a location of the shipping container based on network infrastructure detected by the processing device. In some of these embodiments, the network infrastructure comprises processing device s associated with one or more other shipping containers. In some of these embodiments, the processing device is configured to determine a location of the shipping container based on absence or presence of a shipping scan-code associated with the shipping container. In some of these embodiments, the processing device is configured to determine a location of the shipping container based on GPS derived coordinates. In some of these embodiments, the processing device is configured to determine a location of the shipping container based on one or more factors including an outside temperature, a sound frequency, altitude and time-in-transit.

In some of these embodiments, information transmitted by the processing device is fused with data received from a carrier. In some of these embodiments, the data received from the carrier includes one or more of custody transfer, time, state, and weight information.

In some of these embodiments, the bladder has a shape adapted to conform to certain contours of the shipping container, thereby providing maximum protection of the Thermal Source and the one or more commodities. In some of these embodiments, the bladder has a shape that minimizes movement of an inner chamber of the container. In some of these embodiments, the bladder has a shape that accommodates protrusions from a Dewar, including handles and fill tubes. In some of these embodiments, the bladder has one or more pockets that hold commodities, accessories or documentation.

In some of these embodiments, a processing device attached to the bladder measures the pressure of at least one bladder segment. Some of these embodiments comprise a band configured to maintain the bladder in a desired position. In some of these embodiments, a strain gauge measures the stress load of the band, the stress load being indicative of the weight of the Thermal Source. In some of these embodiments, the measurement of the stress load of the band is used to determine the weight of the one or more commodities. In some of these embodiments, the bladder absorbs shock and vibration. In some of these embodiments, the bladder is multi-segmented, each segment maintaining a uniform pressure such that vectors of arrival of the shock and vibration are perpendicular to the one or more commodities.

In some of these embodiments, differential pressure between at least a segment of the bladder and external atmospheric pressure is used to adjust pressure measurements responsive to changes in atmospheric pressure. In some of these embodiments, the differential pressure is used to calculate altitude of an aircraft, wherein the altitude is calculated based on acceleration. In some of these embodiments, pressure measurements are based on the evaluation of its tilt or orientation in reference to the center of the earth. In some of these embodiments, the bladder comprises a material or mesh having elastic properties that limit volumetric expansion, thereby assuring accurate pressure measurement.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A shipping container comprising:
an inner space or enclosure adapted to carry a thermal source and one or more commodities during shipment;
at least one transducer configured to determine weight of at least the thermal source and the one or more commodities; and
a processing device configured to receive measurements from the at least one transducer, and to communicate the measurements to a networked device upon detecting the presence of a network, wherein the measurements include a current weight of the thermal source.

2. The shipping container of claim 2, wherein:
the networked device processes the measurements using a cloud-resident application;
the networked device transmits a command to the processing device that causes the processing device to adjust a configuration parameter; and
the configuration parameter configures one or more of a sensor sample interval, a preferred network communication route, an allowed or prohibited network communication route, and a remote control of an annunciator provided on the shipping container.

3. The shipping container of claim 1, wherein the processing device is configured to determine a location of the shipping container based on the presence or absence of network infrastructure detected by the processing device.

4. The shipping container of claim 3, wherein the network infrastructure comprises one or more processing devices associated with one or more other shipping containers.

5. The shipping container of claim 1, wherein the processing device is configured to determine a location of the shipping container based on absence or presence of a shipping scan-code associated with the shipping container.

6. The shipping container of claim 1, wherein the processing device is configured to determine a location of the shipping container based on coordinates derived from a GPS signal, wherein the shipping container is determined to be located within a structure when no GPS signal is detected.

7. The shipping container of claim 1, wherein the processing device is configured to determine a location of the shipping container based on one or more factors including an outside temperature, a sound frequency, altitude, absence or presence of a network and time-in-transit.

8. The shipping container of claim 1, wherein information transmitted by the processing device is fused with data received from a customer or carrier, wherein the data includes one or more of custody transfer, time, state and weight information and networks detected along a shipping route.

9. The shipping container of claim 1, further comprising at least one bladder conformed to the inner surface of the inner chamber and instrumented with the at least one transducer, wherein the at least one bladder comprises a plurality of segments, each segment maintaining a uniform pressure such that vectors of arrival of the shock and vibration is perpendicular to the one or more commodities, and wherein each of the at least one transducer measures the pressure of at least one segment of the bladder.

10. The shipping container of claim 1, further comprising at least one bladder conformed to the inner surface of the inner chamber wherein the at least one bladder has a shape adapted to provide protection of the thermal source and the one or more commodities.

11. The shipping container of claim 1, further comprising:
at least one bladder conformed to an inner surface of the inner chamber; and
a band configured to maintain the at least one bladder in a desired position, wherein the at least one transducer includes a strain gauge configured to measure the stress load of the band, the stress load being indicative of the weight of the thermal source.

12. The shipping container of claim 11, wherein the stress load measures differential pressure between at least a segment of the at least one bladder and external atmospheric pressure, wherein the differential pressure is indicative of the weight of the thermal source.

13. The shipping container of claim 12, wherein one or more of a change detected in radio frequency environment, absence or presence of a network, the differential pressure, a vibration, an acceleration and a tilt is used to determine if the shipping container is on an aircraft or other vehicle.

14. The shipping container of claim 12, wherein pressure measurements are based on an evaluation of tilt or orientation of the shipping container in relation to the center of the earth.

15. The shipping container of claim 12, wherein the at least one bladder comprises a material or mesh having elastic properties that limit volumetric expansion, thereby assuring accurate pressure measurement.

16. The shipping container of claim 11, wherein the measurement of the stress load of the band is used to determine the weight of the one or more commodities.

17. The shipping container of claim 11, wherein the at least one bladder absorbs shock and vibration.

18. The shipping container of claim 1, wherein the at least one transducer is coupled to a plate located under the thermal source.

19. The shipping container of claim 15, wherein the at least one transducer comprises a microelectromechanical system (MEMS) device.
